(19) United States
(12) Patent Application Publication
(10) Pub. No.: US 2014/0226364 A1
(43) Pub. Date: Aug. 14, 2014

(54) BACKLIGHT DEVICE AND DISPLAY DEVICE INCLUDING THE SAME

(71) Applicant: Japan Display Inc., Tokyo (JP)

(72) Inventors: Shimon ITAKURA, Tokyo (JP); Kazuyoshi TANAKA, Tokyo (JP); Kengo KOBAYASHI, Tokyo (JP); Yuzo OTA, Tokyo (JP)

(73) Assignee: Japan Display Inc., Tokyo (JP)

(21) Appl. No.: 14/168,097

(22) Filed: Jan. 30, 2014

(30) Foreign Application Priority Data
Feb. 8, 2013 (JP) 2013-022969

(51) Int. Cl. F21V 8/00

(52) U.S. Cl. CPC G02B 6/0011
USPC 362/613

(57) ABSTRACT

A backlight device includes: a light guide plate; a pair of light sources which is provided along left and right sides of the light guide plate respectively; and a frame which defines positions of the light guide plate and the light sources, wherein the position of the light guide plate with respect to the light sources is defined by a fixing member provided to the frame on upper and lower sides of the light guide plate, and the fixing member biases the light guide plate toward left and right sides of the light guide plate on the upper and lower sides of the light guide plate.

### CROSS-REFERENCE TO RELATED APPLICATION

The present application claims priority from Japanese patent application JP 2013-22969 filed on Feb. 8, 2013, the content of which is hereby incorporated by reference into this application.

### BACKGROUND OF THE INVENTION

1. Field of the Invention

The present invention relates to a backlight device and a display device provided with the backlight device, and more particularly to a backlight device having a sidelight-type light source and a display device provided with the backlight device.

2. Description of the Related Art

For example, as a backlight device which has been conventionally popularly used in a display device or the like, there has been known, in general, a backlight device which includes a light source at a place corresponding to a lower side of a display device and irradiates a light emitted from the light source to a front surface of a display part of the display device through a light guide plate.

Recently, with respect to a backlight device used for a display device, there has been a demand for the emission of large quantity of light for realizing the further enhancement of an image quality of the display device (for example, the acquisition of higher definition of a screen). As measures for making the backlight device emit a large quantity of light, the increase of the number of light emitting bodies which constitute alight source or the increase of a quantity of light which light emitting bodies constituting the light source emit is considered. It is expected, however, the increase of a quantity of light which light emitting bodies constituting the light source emit can enhance the quantity of light by only several % at maximum. Accordingly, it is considered realistic to increase the number of light emitting bodies which constitute a light source for satisfying the above-mentioned request.

In increasing the number of light emitting bodies which constitute a light source, however, there arises one drawback. That is, in general, a drive circuit of a display device or the like is arranged at a place corresponding to an upper side of the display device and hence, in increasing the number of light emitting bodies which constitute a light source, from a viewpoint of heat radiation, it is not desirable to additionally arrange new light sources on the upper side of the display device. Accordingly, to satisfy the above-mentioned demand for the emission of large quantity of light, there has been proposed a so-called sidelight-type surface light emitting device where light sources are arranged at places corresponding to both left and right sides of the display device.

JP-A-2005-78802 discloses a surface light emitting device having a light guide plate and a light source, wherein a light emitting body which constitutes the light source is arranged on a side surface of the light guide plate, and the light emitting body and a light incident portion of the light guide plate are fixed to each other by eliminating an air layer therebetween by a layer which contains at least one of a photo adhesive agent, a photo elastomer and a photo gel.

### SUMMARY OF THE INVENTION

By adopting a sidelight-type backlight device, a demand for enhancement of quantity of a light emitted from a backlight device can be satisfied. However, a new drawback may arise along with the increase of the number of light emitting bodies which constitute a light source.

Heat is gradually accumulated in the light guide plate along with the irradiation of light to the light guide plate from the light source. Since the light guide plate is made of a resin in general, the resin-made light guide plate shrinks or expands to some extent when the light guide plate is exposed to heat from the light source.

Although the light guide plate is arranged so as to emit an approximately uniform quantity of light over the whole light emitting surface of the backlight device, the light guide plate shrinks or expands and hence, a distance between the light guide plate and the light source delicately changes whereby it is difficult for the light irradiated from the backlight device to maintain a uniform light quantity over the whole light emitting surface of the backlight device.

The present invention has been made in view of such circumstances, and it is an object of the present invention to provide a backlight device which includes: a light guide plate; a pair of light sources which is provided along left and right sides of the light guide plate respectively; and a frame which defines positions of the light guide plate and the light sources, wherein the difference in light quantity between lights irradiated from the left and right sides of the backlight device respectively is small even when the light guide plate shrinks or expands.

The above-mentioned and other objects and novel technical features of the present invention will become apparent from the description of this specification and attached drawings.

To overcome the above-mentioned drawbacks, according to one aspect of the present invention, there is provided a backlight device which includes: a light guide plate; a pair of light sources which is provided along left and right sides of the light guide plate respectively; and a frame which defines positions of the light guide plate and the light sources, wherein the position of the light guide plate with respect to the light sources is defined by a fixing member provided to the frame on upper and lower sides of the light guide plate, and the fixing member biases the light guide plate toward left and right sides of the light guide plate on the upper and lower sides of the light guide plate.

In the backlight device having the above-mentioned constitution, the fixing member may include elastic portions which bias the light guide plate toward the left and right sides of the light guide plate on the upper and lower sides of the light guide plate. The fixing member may be provided to the frame such that the fixing member is arranged at the approximately center on the upper and lower sides of the light guide plate. The fixing member may be made of a resin.

It is another object of the present invention to provide a display device which is provided with the above-mentioned backlight device.

According to the present invention, there is provide a backlight device which includes: a light guide plate; a pair of light sources which is provided along left and right sides of the light guide plate respectively; and a frame which defines positions of the light guide plate and the light sources, wherein the difference in light quantity between lights irradiated from the left and right sides of the backlight device respectively is small even when the light guide plate shrinks or expands.

### BRIEF DESCRIPTION OF THE DRAWINGS

FIG. 1 is an exploded perspective view of a backlight device according to one embodiment of the present invention;

FIG. 2 is a plan view of the backlight device according to one embodiment of the present invention;

FIG. 3 is a perspective view showing one example of fixing members of a frame included in the backlight device according to one embodiment of the present invention;

FIG. 4A is a view showing a state where a light guide plate and the fixing member of the frame included in the backlight device according to one embodiment of the present invention are provided;

FIG. 4B is a view showing another state where the light guide plate and the fixing member of the frame included in the backlight device according to one embodiment of the present invention are provided;

FIG. 5A is a view showing a state where a light guide plate and the fixing member of the frame included in the backlight device according to another embodiment of the present invention are provided;

FIG. 5B is a view showing another state where the light guide plate and the fixing members of the frame included in the backlight device according to another embodiment of the present invention are provided;

FIG. 6A is a view showing a state where a light guide plate and the fixing member of the frame included in the backlight device according to still another embodiment of the present invention are provided;

FIG. 6B is a view showing another state where the light guide plate and the fixing member of the frame included in the backlight device according to still another embodiment of the present invention are provided.

### DETAILED DESCRIPTION OF THE INVENTION

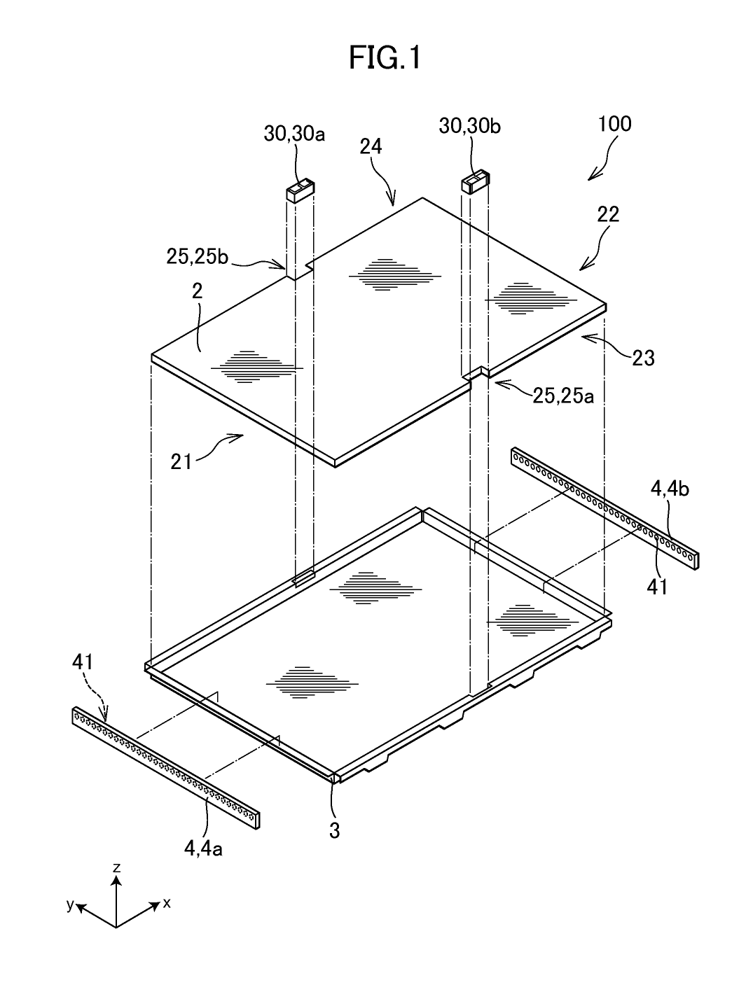

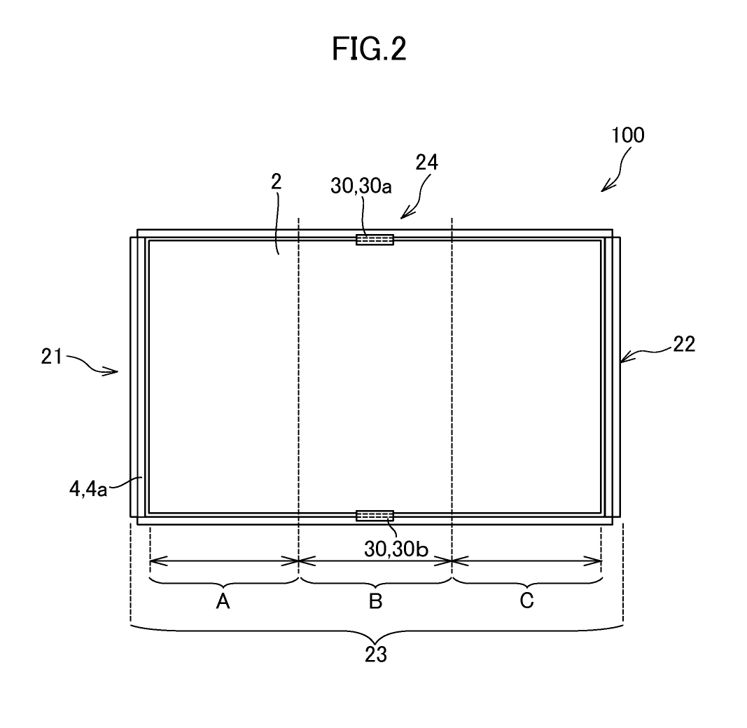

A backlight device according to one embodiment of the present invention is explained in conjunction with drawings. FIG. 1 is an exploded perspective view of a backlight device 100 according to one embodiment of the present invention. FIG. 2 is a plan view of the backlight device 100 according to one embodiment of the present invention.

The backlight device 100 according to one embodiment of the present invention includes: a light guide plate 2; a pair of light sources 4 (4a, 4b) which is provided along left and right sides 21, 22 of the light guide plate 2 respectively; and a frame 3 which defines positions of the light guide plate 2 and the light sources 4. The position of the light guide plate 2 with respect to the light sources 4 is defined by means of fixing members 30 provided to the frame 3 on upper and lower sides 23, 24 of the light guide plate 2. The fixing members 30 bias the light guide plate 2 toward left and right sides 21, 22 of the light guide plate 2 on the upper and lower sides 23, 24 of the light guide plate 2.

As shown in FIG. 1 and FIG. 2, the backlight device according to the present invention is a sidelight-type backlight device. By adopting the sidelight-type backlight device, a demand for enhancement of quantity of a light emitted from the backlight device can be satisfied. However, a new drawback may arise along with the increase of the number of light emitting bodies which constitute a light source.

Heat is gradually accumulated in the light guide plate provided to the backlight device along with the irradiation of light to the light guide plate from the light source. Since the light guide plate is made of a resin in general, the resin-made light guide plate shrinks or expands to some extent when the light guide plate is exposed to heat from the light source.

Although the light guide plate is arranged so as to emit an approximately uniform quantity of light over the whole light emitting surface of the backlight device, the light guide plate shrinks or expands and hence, a distance between the light guide plate and the light source delicately changes whereby it is difficult for the light irradiated from the backlight device to maintain a uniform light quantity over the whole light emitting surface of the backlight device.

To explain this phenomenon more specifically, when the light guide plate thermally shrinks or expands so that the light guide plate is displaced toward either one of left and right sides, a distance between one side of the light guide plate and the corresponding light source becomes smaller than a distance between the other side of the light guide plate and the corresponding light source. Accordingly, a quantity of light irradiated from one side of the light guide plate becomes larger than a quantity of light irradiated from the other side of the light guide plate.

Further, for example, when the backlight device is applied to a display device, it is necessary for the display device to emit uniform light over a display screen of the display device. With respect to the level of uniformity of light emission of the light, the required performance of the display device changes depending on a situation where the display device is used. For example, in a display device such as a television receiver set which has been popularly available, it is often the case where a moving image is displayed on a display screen and hence, the level of uniformity in light emission of light over the whole display screen is not considered so important.

However, in a monitor for surgical operation used in a medical care site or the like, for example, although such a monitor is also a display device, there is a case where a quantity of light emitted to a display part differs depending on a portion of the display part and the difference in quantity of light largely changes an impression of a moving image or a still image displayed on the display part. As the result, there arises a possibility that a doctor makes a serious mistake in his determination during the surgical operation due to such a change in impression.

In view of such circumstances, the inventors of the present invention have measured a quantity of light emitted from a backlight device in a state where a light guide plate is displaced to either one of left and right sides in the backlight device. As the result of the measurement using the 30-inch display device provided with a sidelight-type backlight device, it is found that when distances between the light guide plate of the backlight device and sidelight-type light sources provided along both sides of the light guide plate are displaced by only 0.5 mm, the difference between a quantity of light on a left side of the light guide plate and a quantity of light on a right side of the light guide plate amounts to 10%.

Based on the result of such finding, the inventors have made extensive studies on a backlight device which exhibits small difference in quantity of light between lights irradiated from left and right sides of the backlight device even when the light guide plate shrinks or expands, and have arrived at the backlight device according to the present invention.

In the backlight device 100 according to one embodiment of the present invention shown in FIG. 1 and FIG. 2, lights irradiated from the light sources 4 (4a, 4b) arranged to face the pair of opposite side surfaces of the light guide plate 2 in an opposed manner are made to enter the light guide plate 2 through the side surfaces of the light guide plate 2 and are irradiated from a front surface of the light guide plate 2.

Here, the respective constitutional members which constitute the backlight device 100 according to one embodiment of the present invention are explained in conjunction with drawings.

The light guide plate 2 provided to the backlight device 100 according to one embodiment of the present invention may preferably be made of a material having high optical transmittance. To be more specific, the light guide plate 2 may be made of a material having optical transmittance of 85% or more, or may be made of a material having optical transmittance of 87% or more, or may be made of a material having optical transmittance of 89% or more.

The light guide plate 2 provided to the backlight device 100 according to one embodiment of the present invention may be formed using a resin having high optical transmittance. The light guide plate 2 provided to the backlight device 100 according to one embodiment of the present invention may be formed using polycarbonate (optical transmittance: approximately 90%), for example. The light guide plate 2 provided to the backlight device 100 according to one embodiment of the present invention may be formed using glass having high optical transmittance.

A thickness of the light guide plate 2 may preferably be 10.0 mm or less from a viewpoint of weight or the like. Although a lower limit value of the thickness of the light guide plate 2 is not particularly specified provided that the thickness does not adversely affect a light emitting surface of the light guide plate 2 such as the occurrence of distortion, the thickness of the light guide plate 2 may preferably be 0.3 mm or more, for example.

On the light guide plate 2 provided to the backlight device 100 according to one embodiment of the present invention, notched portions 25 for defining the position where the light guide plate 2 is mounted on the backlight device 100 are formed. The notched portions 25 are formed at positions corresponding to the positions of fixing members 30 (30a, 30b) which the frame 3 includes (explained later).

The frame 3 provided to the backlight device 100 according to one embodiment of the present invention plays a role of maintaining a predetermined positional relationship between the light guide plate 2 and the light sources 4 (4a, 4b). Accordingly, the frame 3 is required to possess rigidity and/or heat resistance (property of not being deformed by heat) to some extent. The frame 3 may be formed using metal such as aluminum, for example, to satisfy required rigidity and/or heat resistance.

The fixing members 30 for defining the positions of the light guide plate 2 and the light sources 4 may not be provided to the left and right sides 21, 22 of the light guide plate 2. That is, the frame 3 may include, as shown in FIG. 1 and FIG. 2, the fixing members 30 (30a, 30b) for fixing the position of the light guide plate 2 only on sides (sides indicated by symbols 23, 24 in FIG. 1 and FIG. 2) perpendicular to sides (sides indicated by symbols 21, 22 in FIG. 1 and FIG. 2) along the sidelight-type light sources 4 (4a, 4b) of the light guide plate 2. In this embodiment, the fixing members 30 (30a, 30b) may be integrally formed with the frame 3 or may be formed as a separate body from the frame 3.

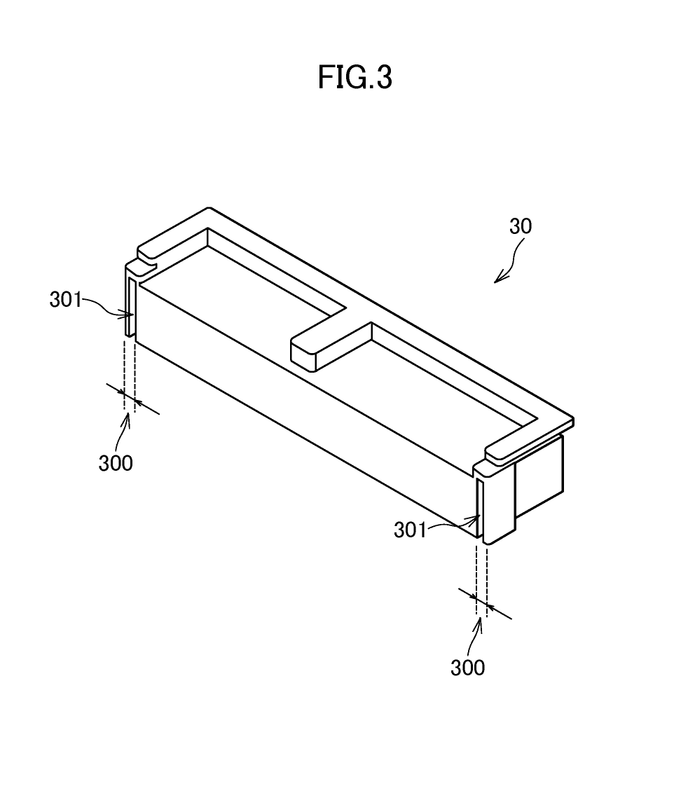

FIG. 3 is a perspective view showing one example of fixing members 30 of the frame 3 included in the backlight device 100 according to one embodiment of the present invention. The fixing members 30 are provided to the frame 3 such that the fixing members 30 bias the light guide plate 2 in the direction that the light sources 4 (4a, 4b) are provided. That is, the fixing members 30 are provided to the frame 3 such that the fixing members 30 bias the light guide plate 2 toward the left and right sides 21, 22 of the light guide plate 2 on the upper and lower sides of the light guide plate 2. The fixing members 30 may be provided to the frame 3 such that the fixing members 30 bias the light guide plate 2 toward the left and right sides 21, 22 of the light guide plate 2 on edges of the upper and lower sides 23, 24 of the light guide plate 2.

Further, as shown in FIG. 3, the fixing member 30 may include resilient portions 300 which bias the light guide plate 2 toward the left and right sides 21, 22 of the light guide plate 2 on both ends thereof respectively. The fixing member 30 may include a resilient portion 300 which biases the light guide plate 2 toward either one of the left and right sides of the light guide plate 2 on one end thereof. In this case, two types of fixing members consisting of the fixing member 30 which biases the light guide plate 2 toward the left side 21 of the light guide plate 2 and the fixing member 30 which biases the light guide plate 2 toward the right side 22 of the light guide plate 2 may be provided to the frame 3 on each of the upper and lower sides 23, 24 of the light guide plate 2.

The resilient portions 300 provided to both ends of the fixing member 30 may be made of rubber, for example, or may be formed of a spring (for example, leaf spring) or the like. The fixing member 30 shown in FIG. 3 is made of a resin and a gap (slit) 301 is formed in both ends of the fixing member 30. Due to such a constitution, the positioning of the light guide plate 2 and the frame 3 is defined by making use of resiliency of the resin and a frictional force between the fixing member 30 and the light guide plate 2.

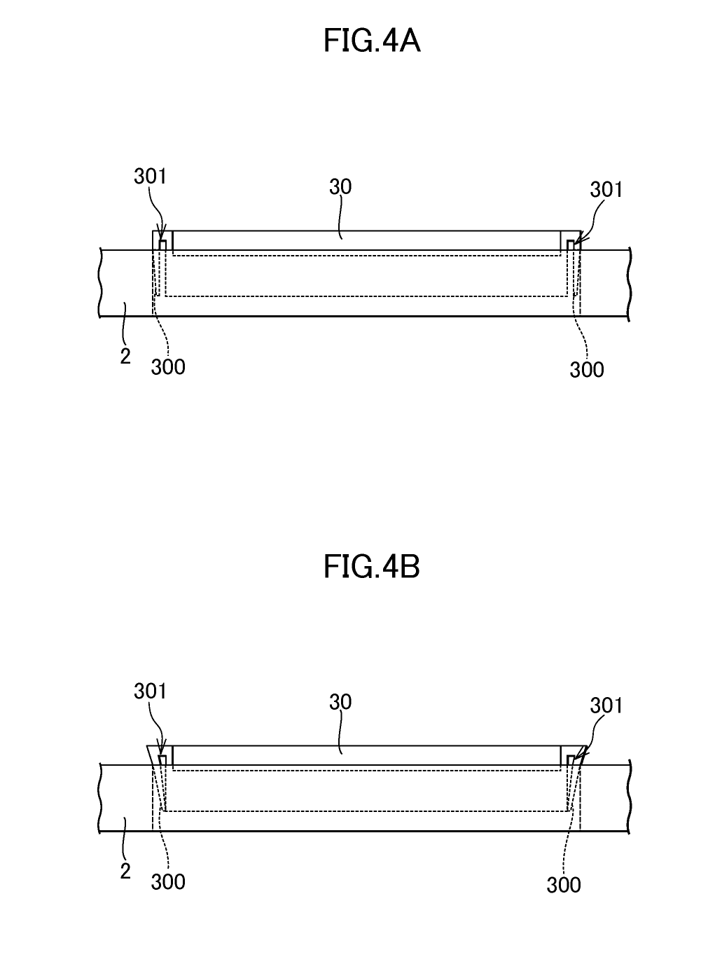

FIG. 4A is a view showing a state where the light guide plate 2 and the fixing member 30 of the frame 3 included in the backlight device 100 according to one embodiment of the present invention are provided. As shown in FIG. 4A, the positioning of the light guide plate 2 and the frame 3 is defined by press-fitting the fixing members 30 (30a, 30b) provided to the frame 3 into the notches 25 provided to the light guide plate 2.

Even when heat is applied to the light guide plate 2 so that the light guide plate 2 expands in the direction that the light guide plate 2 pushes the fixing members 30 (30a, 30b) (X direction in FIG. 1), the gaps (slits) 301 formed in both end portions of the fixing member 30 (30a, 30b) surely allow the expansion of the light guide plate 2 and hence, the displacement of the light guide plate 2 in the lateral direction (in the left-and-right direction) in the backlight device 100 can be avoided.

FIG. 4B is a view showing another state where the light guide plate 2 and the fixing member 30 (30a, 30b) of the frame 3 included in the backlight device 100 according to one embodiment of the present invention are provided. FIG. 4B schematically shows a state where even when heat is applied to the light guide plate 2 so that the light guide plate 2 expands in the direction that the light guide plate 2 pushes the fixing members 30 (30a, 30b) (X direction in FIG. 1), the gaps (slits) 301 formed in both end portions of the fixing member 30 (30a, 30b) surely allow the expansion of the light guide plate 2 and hence, the displacement of the light guide plate 2 in the lateral direction (in the left-and-right direction) in the backlight device 100 can be avoided.

As another example of the fixing member 30, a snap-fit-type joining mechanism may be provided to both end portions of the fixing member 30 shown in FIG. 3. With the provision of the snap-fit-type joining mechanism 302, the light guide plate 2 can be held also in the direction toward the surface of the light guide plate 2 (in the Z direction in FIG. 1) and hence, the accuracy in positioning can be further enhanced.

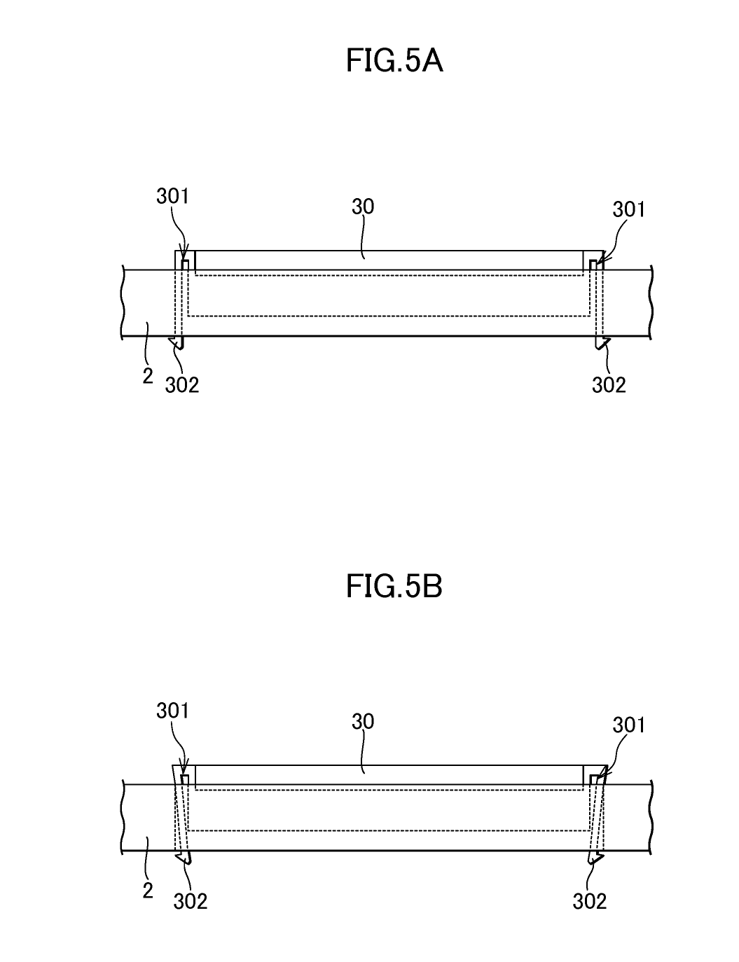

FIG. 5A is a view showing a state where a light guide plate 2 and a fixing member 30 of a frame 3 included in a backlight device 100 according to another embodiment of the present invention are provided. As shown in FIG. 5A, the positioning of the light guide plate 2 and the frame 3 is defined by press-fitting (snap fitting) the fixing members 30 provided to the frame 3 into notches 25 provided to the light guide plate 2.

Even when heat is applied to the light guide plate 2 so that the light guide plate 2 expands in the direction that the light guide plate 2 pushes the fixing members 30, gaps (slits) 301 formed in both end portions of the fixing member 30 (30a, 30b) surely allow the expansion of the light guide plate 2 and hence, the displacement of the light guide plate 2 in the lateral direction (in the left-and-right direction) in the backlight device 100 can be avoided.

FIG. 5B is a view showing another state where the light guide plate 2 and the fixing member 30 of the frame 3 included in the backlight device 100 according to another embodiment of the present invention are provided. FIG. 5B schematically shows a state where even when heat is applied to the light guide plate 2 so that the light guide plate 2 expands in the direction that the light guide plate 2 pushes the fixing member 30, the gaps (slits) 301 formed in both end portions of the fixing member 30 surely allow the expansion of the light guide plate 2 and hence, the displacement of the light guide plate 2 in the lateral direction (in the left-and-right direction) in the backlight device 100 can be avoided.

As another example of the fixing member 30, rubber may be provided to both end portions of the fixing member 30 shown in FIG. 3. By providing rubber to both end portions of the fixing member 30, even when the light guide plate 2 expands and is pushed by the rubbers, the light guide plate 2 can be pressed by surfaces and hence, the accuracy in positioning can be further enhanced when the light guide plate 2 expands.

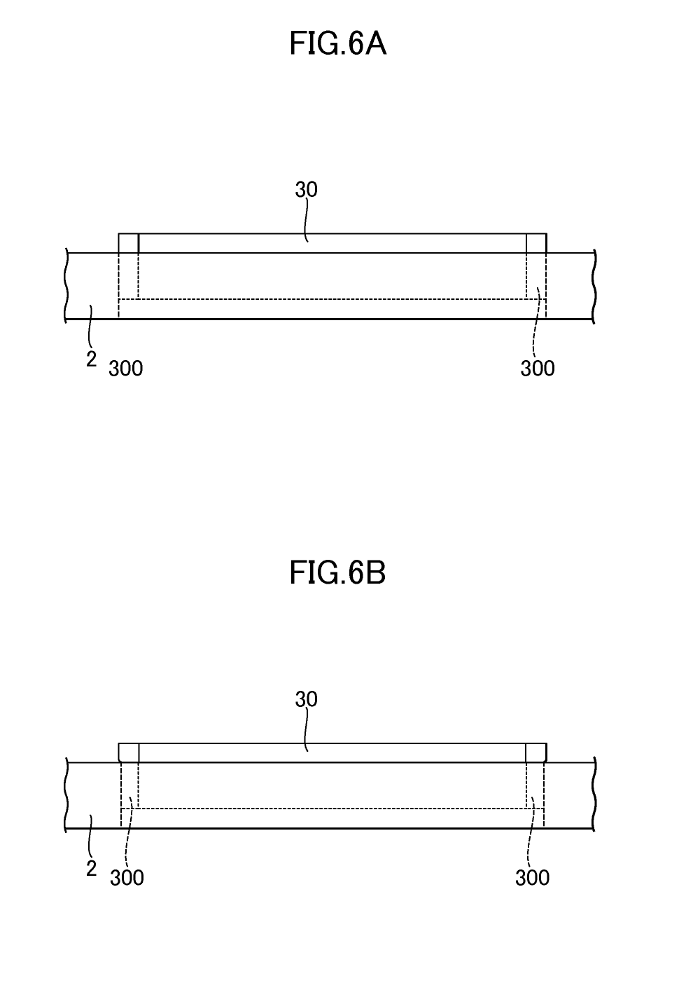

FIG. 6A is a view showing a state where a light guide plate 2 and a fixing member 30 of a frame 3 included in a backlight device 100 according to still another embodiment of the present invention are provided. As shown in FIG. 6A, the fixing of the light guide plate 2 and the frame 3 to each other is realized by press-fitting the fixing members 30 provided to the frame 3 into notches 25 provided to the light guide plate 2.

Even when heat is applied to the light guide plate 2 so that the light guide plate 2 expands in the direction that the light guide plate 2 pushes the fixing members 30, rubber provided to both end portions of the fixing member 30 shrinks and hence, rubber surely allows the expansion of the light guide plate 2 whereby the displacement of the light guide plate 2 in the lateral direction (in the left-and-right direction) in the backlight device 100 can be avoided.

FIG. 6B is a view showing another state where the light guide plate 2 and the fixing member 30 of the frame 3 included in the backlight device 100 according to still another embodiment of the present invention are provided. FIG. 6B shows a state where even when heat is applied to the light guide plate 2 so that the light guide plate 2 expands in the direction that the light guide plate 2 pushes the fixing members 30, rubbers provided to both end portions of the fixing member 30 defines the positions of the light guide plate 2 and the frame 3 by the whole surfaces of the rubbers on a side where the rubbers are brought into contact with the light guide plate 2.

The fixing members 30 which have been explained heretofore may be provided to the frame 3 such that the fixing members 30 are positioned at the approximately center on the upper and lower sides 23, 24 of the light guide plate 2. Alternatively, the fixing members 30 which have been explained heretofore may be provided to the frame 3 such that the fixing members 30 are positioned in a center portion when the light guide plate 2 is divided in three on the upper and lower sides 23, 24 of the light guide plate 2. That is, the fixing members 30 may be provided within a region B on the upper and lower sides 23, 24 of the light guide plate 2 shown in FIG. 2.

When heat is applied to the light guide plate 2 so that the light guide plate 2 shrinks or expands, portions where a change in size occurs most conspicuously are left and right peripheral edge portions of the light guide plate 2. For example, when the fixing members 30 are arranged in a region A which is a region close to the left peripheral edge portion of the light guide plate 2 in FIG. 2, for example, both ends of the fixing member 30 receive a high pressing force compared to a case where the fixing members 30 are arranged in the region B which is a region remote from the left and right peripheral edge portions of the light guide plate 2 and hence, there exists a possibility that the resilient portions 300 provided to both ends of the fixing member 30 cannot surely allow the expansion of the light guide plate 2. In such a case, a force which distorts the light guide plate 2 in the direction toward the front surface of the light guide plate 2 (in the Z direction in FIG. 1) is added to the light guide plate 2 thus giving rise to a possibility that the uniformity of the irradiation of light from the backlight device 100 is lowered.

The light source 4 (4a, 4b) provided to the backlight device 100 according to one embodiment of the present invention is constituted of a plurality of light emitting bodies 41. That is, the backlight device 100 according to one embodiment of the present invention includes the plurality of light emitting bodies 41 provided along both left and right sides 21, 22 of the light guide plate 2. For example, in the light source 4 (4a, 4b), the plurality of light emitting bodies 41 may be arranged in a spaced-apart manner at intervals of 2 to 15 mm from each other or may be arranged in a spaced-apart manner at intervals of 5 to 10 mm from each other.

The light emitting body 41 may be constituted of an LED. By using an LED which exhibits excellent linearity of light as the light emitting body 41, a light enters the light guide plate 2 more surely. As the result, a quantity of light irradiated from the whole backlight device 100 can be increased.

The light sources 4 (4a, 4b) and the frame 3 provided to the backlight device 100 according to one embodiment of the present invention may be directly fixed to each other. That is, the frame 3 and the light sources 4 (4a, 4b) may be directly fixed to each other by screws or the like, for example. Alternatively, the light sources 4 (4a, 4b) and the frame 3 provided to the backlight device 100 according to one embodiment of the present invention may be fixed to each other by an adhesive agent or the like.

The backlight device 100 according to one embodiment of the present invention may include a reflector between a surface of the light guide plate 2 on a side opposite to a surface of the light guide plate 2 from which a light is irradiated and the frame 3.

As shown in FIG. 1 and FIG. 2, the frame 3 of the backlight device 100 according to one embodiment of the present invention may be arranged so as to surround the whole outer edges of the light guide plate 2. This structure increases rigidity of the frame 3 thus further increasing the advantageous effects of the present invention.

The light sources 4 (4a, 4b) may be provided between the frame 3 and the light guide plate 2 in a spaced-apart manner from the light guide plate 2. Due to such structure, when heat is accumulated in the light guide plate 2 due to the irradiation of light to the light guide plate 2 from the light sources 4 (4a, 4b) so that the light guide plate 2 shrinks or expands, it is possible to prevent the light guide plate 2 from being brought into contact with the light sources 4 (4a, 4b). That is, it is possible to avoid a phenomenon that the light guide plate 2 which shrinks or expands due to heat is physically brought into contact with the light sources 4 (4a, 4b) so that the light guide plate 2 is deflected in the direction toward the front surface of the light guide plate 2 (in the Z direction in FIG. 1). This structure increases rigidity of the frame 3 thus further enhancing the advantageous effects of the present invention.

When the backlight device 100 according to the present invention is applied to a display device, the difference in light quantity between left and right sides of a display part of the display device may be set to a value which falls within a range of 6%. For example, when the display device has a 30-inch display part, the setting of the difference in light quantity between the left and right sides of a display part of the display device within a range of 6% means that a maximum value of the width of displacement of the light guide plate 2 in the backlight device 100 falls within a range of 0.3 mm.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A backlight device comprising:
a light guide plate;
a pair of light sources which is provided along left and right sides of the light guide plate respectively; and
a frame which defines positions of the light guide plate and the light sources, wherein
the position of the light guide plate with respect to the light sources is defined by a fixing member provided to the frame on upper and lower sides of the light guide plate, and
the fixing member biases the light guide plate toward left and right sides of the light guide plate on the upper and lower sides of the light guide plate.

2. The backlight device according to claim 1, wherein the fixing member includes a resilient portion which biases the light guide plate toward the left and right sides of the light guide plate on the upper and lower sides of the light guide plate.

3. The backlight device according to claim 1, wherein the fixing members is provided to the frame such that the fixing member is arranged at the approximately center on the upper and lower sides of the light guide plate.

4. The backlight device according to claim 1, wherein the fixing member is made of a resin.

5. A display device provided with the backlight device according to claim 1.
